(19) United States
(12) Patent Application Publication
(10) Pub. No.: US 2003/0089558 A1
(43) Pub. Date: May 15, 2003

(54) Power line carrier used in elevator system

(75) Inventors: Bruce Zepke, Glastonbury, CT (US); Robert Morgan, Bolton, CT (US); Bukola S. Dademade, Tucson, AZ (US); Chet Slabinski, New Hartford, CT (US)

Correspondence Address: Christopher R. Pastel, Esq., Wall Marjama & Bilinski, Suite 400, 101 South Salina Street, Syracuse, NY, 13202, US

(73) Assignee: Otis Elevator Company

(21) Appl. No.: 10/037,077

(22) Filed: Nov. 9, 2001

(51) Int. Cl. B66B 7/00

(52) U.S. Cl. 187/413

(57) ABSTRACT

An elevator system includes power line carrier (PLC) interfaces associated with each hallway fixture. The hallway fixtures thus do not need separate control wiring in addition to their power lines. An interface box at the system controller converts the PLC signals to a format understood by the system controller. Communications between an elevator car and the system controller can also be passed in PLC format over the car's power cables.

### FIELD OF THE INVENTION

This invention relates to the use of a power line to carry communications, and in particular, to using a power line carrier in an elevator system to communicate between an elevator controller and the hall fixtures of the system.

### BACKGROUND OF THE INVENTION

A conventional elevator system includes hallway fixtures on each floor. These fixtures include up and down call buttons, lights that indicate when an elevator car has arrived and the direction of travel, and a gong that audibly signals the arrival of the elevator car. In many large office buildings, each elevator has an associated position indicator that tells a user which floor the car is currently on. The typical elevator system uses a controller for each car as well as a system controller for the whole system. Large systems group a bank of elevators into a group, which has its own controller. All of these controllers communicate with the hall fixtures, whether to receive a request for an elevator call (when someone presses an UP or DOWN button) or to provide information to the position indicator to let people know where a given car is at any given moment. This communication is typically done using hard wires. In large systems with several groups each serving 15-25 floors, the amount of wiring is enormous. Maintenance and upgrade of the embedded wiring system is often difficult.

In the power line carrier (PLC) concept, data signals are impressed on the power wiring, AC or DC, and later recovered at the receiving end. PLC technology was originally developed for electric utility companies to transmit signals over long distances between substations via the high-voltage power transmission lines. More recently, the technology has been adapted in several different forms for signal transmission over the AC power lines within a building. PLC has been successfully used in a wide variety of applications including home automation and security, industrial controls and factory automation, monitoring of ship-board refrigerated containers, utility telemetering, point-of-sale networks in retail stores, public transit vehicles, and local area data networks.

### SUMMARY OF THE INVENTION

Briefly stated, an elevator system includes power line carrier (PLC) interfaces associated with each hallway fixture. The hallway fixtures thus do not need separate control wiring in addition to their power lines. An interface box at the system controller converts the PLC signals to a format understood by the system controller. Communications between an elevator car and the system controller can also be passed in PLC format over the car's power cables.

According to an embodiment of the invention, an elevator system includes at least one elevator car moving between at least two stop positions; a system controller; each stop position having at least one fixture for sending and/or receiving signals from the system controller; the at least one fixture receiving power from a power line; an interface between each of the at least one fixtures and the power line which converts the signals to a first format wherein the signals are carried over the power line, and vice versa; and an interface between the system controller and the power line which converts the signals on the power line from the first format to a second format whereby the signals are intelligible to the system controller, and vice versa.

### BRIEF DESCRIPTION OF THE DRAWINGS

FIG. 1 shows an elevator system according to the prior art.

FIG. 2 shows a schematic of the use of power line carrier interface devices to send and receive signals between hallway fixtures and a system controller according to an embodiment of the present invention.

### DETAILED DESCRIPTION OF THE PREFERRED EMBODIMENT

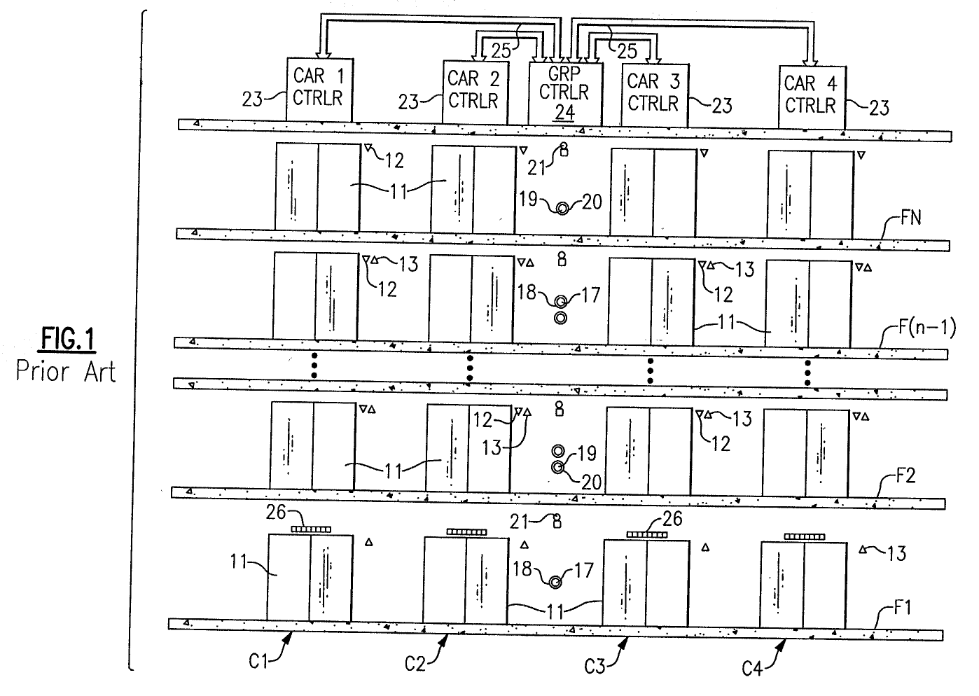

Referring to FIG. 1, an elevator system according to the prior art serves a plurality of stops, such as floors F1-FN. In this example, there are four elevator hoistways C1-C4, with each floor F1-FN having, for each of the hoistways C1-C4, a directional lantern set which includes a down lantern 12 for each floor (except the lowest floor) and an up lantern 13 for each floor (except the highest floor). Each of the floors except the top floor FN has an up service call request button 17 with an associated call-registered light 18, that may include the conventional “halo” or ring surrounding the button 17. Pressing button 17 informs a group controller 24 that a passenger desires to travel upward from that floor. When group controller 24 registers the call, it sends a signal back to illuminate light 18 to inform the passenger that the call is registered. Each of the floors except the lowermost floor F1 has a down service call button 19 and a corresponding light 20 that works in similar fashion.

At each stop, a gong 21 is sounded when a car in any one of the hoistways C1-C4 is about to stop on the corresponding floor. Each car preferably has its own associated gong. Each of the hoistways C1-C4 has a corresponding car controller 23, with the group being supervised by group controller 24. The car controllers are interconnected with group controller 24 by wire cables 25. This, of course, is no difficulty since it occurs on a machine floor where the wiring can be channeled through easily accessible ducts or within the space rather than in the walls. On important floors, such as lobby floors, each of the hoistways C1-C4 has a car position indicator 26 that at any moment when the car is in service, displays the committable position of the corresponding car. A conventional elevator cab (not shown) communicates with its car controller 23 by means of a traveling cable (not shown) that hangs within the hoistway.

In the present invention, since wires are already present and power is needed for the fixtures, these wires can be used for communications. The most basic measure of whether PLC is acceptable for a specific purpose is data rate capability. For a wireless hall fixture, it is assumed that data (bit) rates should at least match the network speed of 10 kbits/sec for controllers such as the Otis E411 currently used in modernization and new construction. Therefore, this metric was used to determine feasibility of available PLC hardware.

The path that a typical power line communication signal might traverse starts from a wall socket and passes through the building's electrical wiring and circuit breaker panel, across power phases, and ultimately to another wall socket. Each socket in the power network may power a device that generates noise and loads the transmitted signal. In all PLC systems, the signal to be transmitted is modulated onto a carrier before being capacitively or inductively coupled onto the power line. The carrier frequencies are limited by regulatory agencies so they will not interfere with commercial radio broadcast. In addition, power line wiring would prove too lossy for very high frequency signals. Systems generally operate with data rates of 10 to 20 Kbits/sec, in the US and less than 5 Kbits/sec in Europe.

Signal attenuation is one issue of concern with PLC. Attenuation is most easily understood in terms of a voltage-divider circuit formed by the output impedance of the transmitter, the impedance of the various mains circuit branches, and any loads present on the mains branch circuits. At the communication frequencies of the PLC transceivers, the significant impedances are due to the series inductance of the mains wiring itself, capacitive loads between line and neutral, resistive loads between line and neutral, and the coupling between phases which occurs due to mutual inductance and parasitic capacitance. The system can be modeled to illustrate that minimizing the series impedances and maximizing the line-to-return path impedances reduces the attenuation of the transmitted signal. Where power transformers are in the path, bridging circuits can be used to bypass each transformer.

The variation in types and number of loads seen at any given instant in time also makes the attenuation frequency dependent. To overcome this, direct sequence spread spectrum (DSSS) modulation and digital signal processing (DSP) are preferred. The other major factor having an effect on communications on the power line is impulsive noise. Power line noise has been found to be highly impulsive in nature, largely as a result of loads turning on and off, such as motors, compressors and lights, and switching power supplies. The effects of this noise are suppressed to varying degrees by using spread spectrum modulation, DSP, limiting data packet size, filtering, and using error correction techniques.

The regulatory environment for power line communications must also be considered. In the US, the FCC allows power line carrier operations as long as the conducted and radiated emissions fall below the Part 15 limits. Generally, modulation frequencies used are between 9 KHz and 30 MHz. in Europe, CENELEC mandates conducted power emissions under 150 kHz in three distinct bands, depending on the application and protocol used. Japanese MPT regulations are among the most stringent. These constraints provide a bandwidth limit of what can be coupled onto the power line, and they require that the coupled signal have minimum distortion. Under the FCC rules, hardware suppliers have achieved data rates of up to 14 Mbps. Available CENELEC-compliant hardware only reaches 4.8 kbits/sec at best. This effectively limits the use of this invention to North America unless lower data rates are suitable for certain elevator applications. In addition to conductive emissions considerations, the interface to the power line must be safe (per UL and CE standards) and able to withstand the high voltage surges and transients that are characteristic of low-voltage AC power lines.

The art of PLC technology is well known and off the shelf hardware is readily available from many suppliers in the U.S., including X-10, Intellon, Echelon, Adaptive Networks and others. Data transmission rates and noise rejection are dependent on the carrier frequency and modulation technique used. X-10 has the lowest cost hardware but also has the lowest data rate and least robust modulation scheme. With X-10, the data are synchronized to the power line AC frequency such that one bit per AC cycle is transmitted. Narrow band frequency modulation and binary phase shift keyed (BPSK) modulation are used in somewhat more sophisticated systems to raise the data rates to 4 Kbi ts/sec. The most robust hardware with the highest data rate uses direct sequence spread-spectrum (DSSS) modulation to achieve data rates up to 20 Mbits/sec.

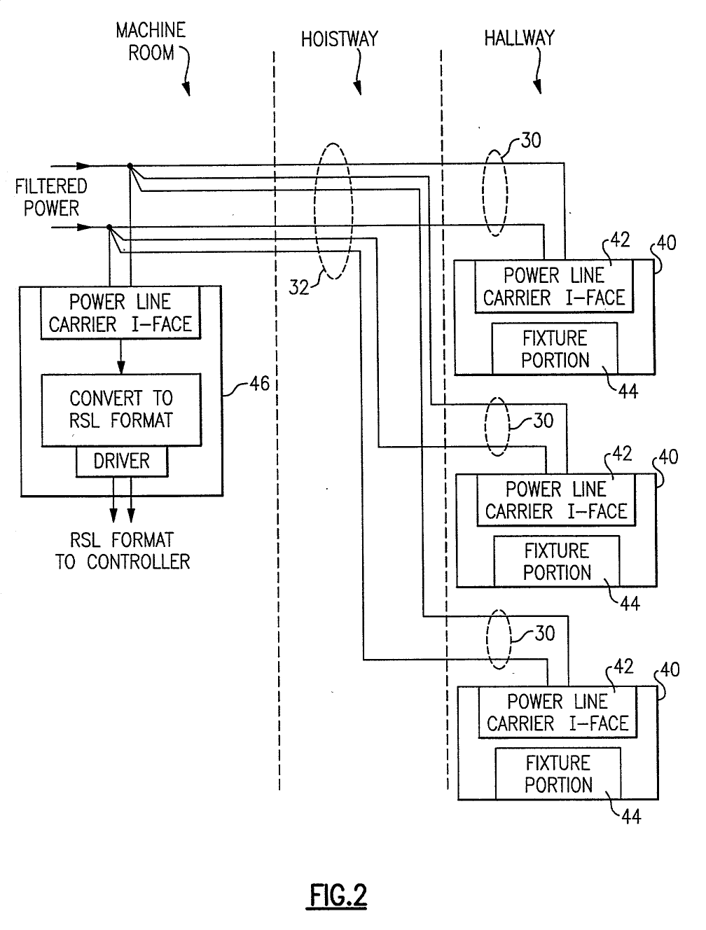

Referring to FIG. 2, fixtures 40 include a fixture portion 44 along with a PLC interface 42. A pair of power wires 30 connect each of the fixtures 40 to the controller via a PLC interface box 46. All of the wires 30 collectively are shown as wiring 32 in the figure. To retrofit an existing installation, a pair of existing wires 30 formerly connecting the old fixtures to the old controller are used to connect each of the new fixtures 40 to the new controller via PLC interface box 46. Wiring 32 carries AC power along with the PLC signals. Since wiring, 32 is dedicated to the fixture network, the problems associated with using the building's main power are eliminated. The power for the hallway fixtures preferably comes, from the machine room, but possibly has impulsive noise generated by the elevator drives. These lines could easily be filtered to eliminate most of the drive-generated noise. This system could be configured using either the Echelon or Adaptive Networks hardware described above.

For further understanding, consider the following sequence in which boldface type indicates PLC transmissions of the invention when the communications between the elevator car controller and the group controller elevator are over a hanging cable.

1. Down button pressed on F2 (floor 2)

2. F2 transmits “down request F2”, addressed to group

3. Group registers down call request on F2

4. Group transmits “turn on down button light”, addressed to F2

5. Group assigns call to car 3

6. Group sends “stop on 2” to car 3 control

7. Car 3 sends “committable floor car 3=F2” to group control

8. Group transmits “turn on car 3 position=F2” addressed to lobby

9. Group transmits “sound gong, turn on down lantern car 3, turn off down button lights”, addressed to F2

10. Car 3 stops with its door opening

11. Door of car 3 closes

12. Car 3 sends “door fully closed” to car 3 controller

13. Car 3 controller sends “door fully closed, car 3” to group controller

14. Group transmits “turn off down lantern, car 3”, addressed to F2

15. Car 3 control sends “committable floor car 3=lobby” to group controller

16. Group transmits “turn on car 3 position=lobby” addressed to lobby

17. Group transmits “sound gong, turn on lantern, car 3, turn off button light” addressed to lobby

In an alternate embodiment, the communications between the elevator car controller and the group controller elevator are over the power lines of the hanging cable instead of being transmitted over separate control lines.

The car controllers and group controller may each be implemented in a separate processor, may be implemented in a distributed processing system such as disclosed in U.S. Pat. No. 5,202,540, or may all be in one processor. As used herein, the term “controller” means any single one or combination of the foregoing. As used herein, “elevator” is not limited to vertical movement, but also includes horizontal movement or movement in other directions, whether assisted by gravity and/or centripetal force or not.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. An elevator system, comprising:
at least one elevator car moving between at least two stop positions;
a system controller;
each stop position having at least one fixture for sending and/or receiving signals from said system controller;
said at least one fixture receiving power from a power line;
an interface between each of said at least one fixtures and said power line which converts said signals to a first format wherein said signals are carried over said power line, and vice versa; and
an interface between said system controller and said power line which converts said signals on said power line from said first format to a second format whereby said signals are intelligible to said system controller, and vice versa.

2. A system according to claim 1, wherein said at east one elevator car includes a car controller, further comprising an interface between said car controller and said power line which converts signals from said car controller to said first format wherein said signals are carried over said power line.

3. A system according to claim 1, further comprising:
a group controller;
a group of elevator cars, wherein said grout controller controls said group; and
an interface between said group controller and said power line which converts signals from said group controller to said first format wherein said signals are carried over said power line.
